(19) United States
(12) Patent Application Publication
(10) Pub. No.: US 2012/0067426 A1
(43) Pub. Date: Mar. 22, 2012

(54) BALL-SEAT APPARATUS AND METHOD

(75) Inventors: Mohan L. Soni, Katy, TX (US); Gaurav Agrawal, Aurora, CO (US)

(73) Assignee: BAKER HUGHES INCORPORATED, Houston, TX (US)

(21) Appl. No.: 12/887,294

(22) Filed: Sep. 21, 2010

(51) Int. Cl. F15D 1/00

(52) U.S. Cl. 137/1; 137/560

(57) ABSTRACT

An apparatus for restricting fluid flow includes: a ball receiving element disposed in a fluid conduit and configured to receive a ball that has been advanced through the fluid conduit and at least partially restrict fluid flow; and at least one seating element at least partially disposed within the fluid conduit, the at least one seating element including at least one of: a shape that extends radially into the fluid conduit and is contoured axially to reduce a rate of deceleration of the ball upon contact with the ball receiving element, and a radially compliant element configured to reduce an impact between the ball and the ball receiving element.

### BACKGROUND

In the drilling and completion industry and for example in hydrocarbon exploration and recovery operations, a variety of components and tools are lowered into a borehole for various operations such as production operations, for example. Some downhole tools utilize ball-seat assemblies to act as a valve or actuator. Ball-seat assemblies are used with, for example, hydraulic disconnects, circulating subs and inflatable packers.

Actuation of a ball-seat assembly generally includes releasing a ball or other plug into a fluid conduit and allowing the ball to drop onto the ball seat and restrict fluid flow therein. The impact between the ball and the ball seat can produce pressure waves, which can cause wear and/or damage to components of the assembly.

### SUMMARY

An apparatus for restricting fluid flow includes: a ball receiving element disposed in a fluid conduit and configured to receive a ball that has been advanced through the fluid conduit and at least partially restrict fluid flow; and at least one seating element at least partially disposed within the fluid conduit, the at least one seating element including at least one of: a shape that extends radially into the fluid conduit and is contoured axially to reduce a rate of deceleration of the ball upon contact with the ball receiving element, and a radially compliant element configured to reduce an impact between the ball and the ball receiving element.

A method of restricting fluid flow includes: releasing a ball into a fluid conduit and receiving the ball in a ball receiving element disposed at the fluid conduit and at least partially restricting fluid flow; and reducing an impact between the ball and the ball receiving element by at least one seating element at least partially disposed within the fluid conduit, the at least one seating element including at least one of: a contour defining a shape that extends radially into the fluid conduit and is contoured axially to reduce a rate of deceleration of the ball upon contact with the ball receiving element, and a radially compliant element configured to reduce an impact between the ball and the ball receiving element.

An apparatus for restricting fluid flow includes: a carrier configured to be disposed in a borehole in an earth formation, the carrier including a fluid conduit; a ball receiving element at least partially disposed in the fluid conduit and configured to receive a ball that has been advanced through the fluid conduit to at least partially restrict fluid flow, the ball receiving element including: a shape that extends radially into the fluid conduit and is contoured axially to reduce a rate of deceleration of the ball upon contact with the ball receiving element; and a damping assembly configured to reduce an impact between the ball and the ball receiving element, the damping assembly including a radially extending spring element operably connected to a damping element, the damping element configured to proportionally resist radial movement of at least one of the spring element and the ball receiving element.

### BRIEF DESCRIPTION OF THE DRAWINGS

The following descriptions should not be considered limiting in any way. With reference to the accompanying drawings, like elements are numbered alike:

FIG. 1 is a cross-sectional view of an embodiment of a ball-seat assembly;

FIG. 2 is a partial cross-sectional view of the ball-seat assembly of FIG. 1 including an axial contour; and

FIG. 3 is a partial cross-sectional view of the ball-seat assembly of FIG. 1 including a compliant ball seat element;

FIG. 4 is a partial cross-sectional view of the ball-seat assembly of FIG. 3 in an actuated position;

FIG. 5 is a partial cross-sectional view of the ball-seat assembly of FIG. 1 including a ball seat element having a compliant surface region;

FIG. 6 is a partial cross-sectional view of the ball-seat assembly of FIG. 1 including a ball seat element having a damping element; and

FIG. 7 is a flow diagram depicting a method of restricting fluid flow in a conduit.

### DETAILED DESCRIPTION

The apparatuses, systems and methods described herein provide for reducing impact between a ball and a ball receiving element such as a ball seat, and for the mitigation of pressure waves caused by actuation of a ball-seat assembly. A downhole assembly includes a conduit having a longitudinal component to guide a ball released into the conduit to a receiving element such as a ball seat. The ball receiving element includes at least one seating element that extends radially into the conduit. In one embodiment, the seating element is axially contoured to reduce the impact between the ball and the ball seat and/or increase the duration of closure or actuation of the ball seat. In one embodiment, the seating element includes a radially compliant portion that includes, for example, a spring element and/or an elastomeric element that radially deforms, retracts or otherwise moves in response to contact with the ball. In one embodiment, a damping mechanism such as a dashpot is operably connected to the spring element and/or the compliant portion to resist movement and/or oscillation and accordingly reduce pressure waves caused by impact between the ball and the ball seat.

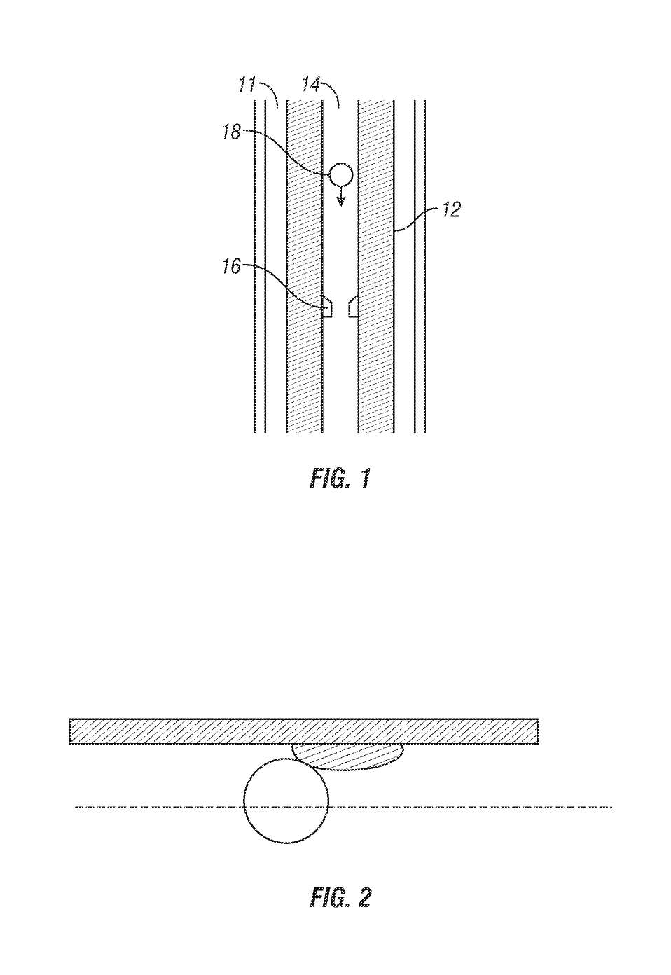

Referring to FIG. 1, a downhole tool 10, such as a ball seat sub, configured to be disposed in a borehole 11, includes a housing 12 or other carrier having a longitudinal bore or fluid conduit 14. A ball-seat assembly includes a ball seat 16 included in the conduit 14 to retain a ball 18 that is released into the conduit 14. In one embodiment, the ball 18 is a spherical metal or plastic plug, although “ball” may refer to any type of moveable or droppable plugging element, such as a drop plug, and may take any desired shape or size. Actuation of the ball seat assembly includes releasing the ball into the fluid conduit 14, for example by dropping the ball 18 into and/or pumping the ball 18 through the fluid conduit 14 from a surface or downhole location. The ball 18 falls and/or is advanced axially by downhole fluid toward the ball seat 16 and is seated on the ball seat 16 to restrict fluid flow through the conduit 14. As described herein, “axial” refers to a direction that is at least generally parallel to a central longitudinal axis of the conduit 14. “Radial” refers to a direction along a line that is orthogonal to the longitudinal axis and extends from the longitudinal axis. As described herein, “downstream” refers to the direction of movement of the ball and/or the downhole fluid, and “upstream” refers to a direction opposite the direction of movement of the ball and/or the downhole fluid.

The ball seat 16 may be an annular component connected to the conduit 14, or any other device or configuration providing a restriction in the diameter or cross-sectional area of the conduit 14 sufficient to prevent the ball 18 from passing therethrough. In one embodiment, the ball seat 16 is directly disposed on and/or attached to the inner surface of the conduit 14 or is partially embedded in the conduit 14. In one embodiment, the ball seat 16 is disposed on or is part of a movable component 20 such as a sliding sleeve for use, for example, as an actuator or valve. The ball seat 16 may be configured to retain the ball 18 in a fixed position to fully or partially restrict fluid flow through the conduit 14, or may be configured to allow the ball 18 to contact the ball seat 16 and continue to move downstream after interacting with the ball seat 16 to, e.g., move an actuator.

Referring to FIG. 2, the ball seat 16 includes at least one seating member or seating element 22 disposed at the conduit 14 and protruding radially into the conduit 14. In one embodiment, the seating element 22 is axially profiled or contoured along the conduit axis to slow the instantaneous impact velocity of the ball 18 on the ball seat 16 and reduce the rate of deceleration of the ball 18. This reduction reduces the transferred momentum and thus the surge pressure on the ball seat 16 and other components. In the example shown in FIG. 2, the protruding portion of the seating element 22 has a shape that is axially contoured to gradually reduce the inner ball seat diameter and area, and gradually extend further into the conduit as the seating element 22 extends from an upstream location to a downstream location. Exemplary shapes include a tapered, beveled or elliptical shape.

In one embodiment, the seating element 22 is a radially compliant element, having at least a portion of the seating element 22 that deforms, yields, retracts or otherwise moves radially outwardly in response to contact with the ball 18 or other plugging element. The seating element 22 is, for example, at least partially deformable in response to contact with the ball 18. In another example, the seating element 22 is connected to a spring or biasing component to allow the seating element 22 to retract radially in response to contact with the ball 18.

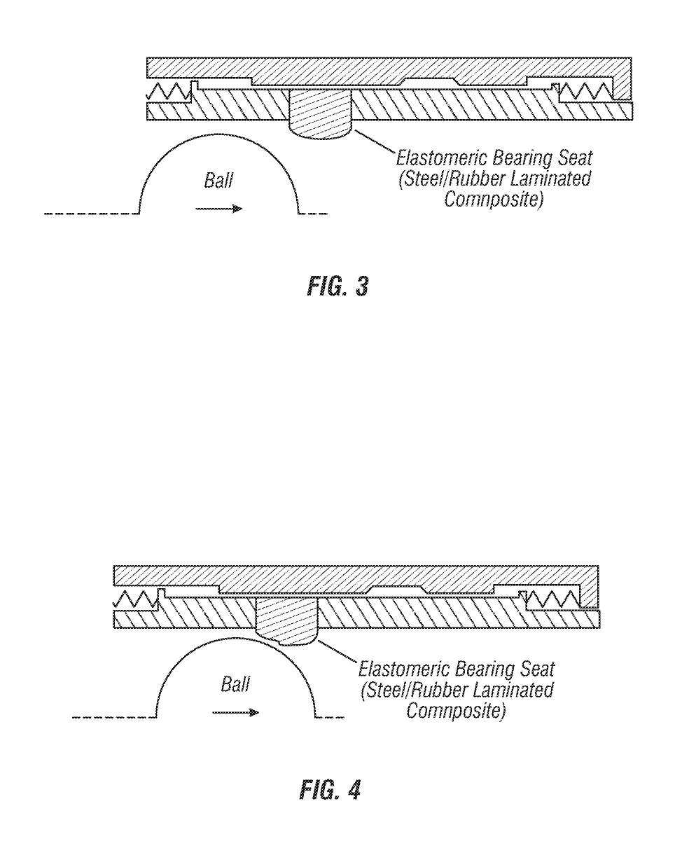

One embodiment of the ball seat assembly is shown in FIGS. 3 and 4, in which the seating element 22 is at least partially made from an elastomeric material or other compliant material 24, such as rubber, plastic, or a steel/rubber laminated composite. FIG. 3 shows the seating element 22 in an undeformed position prior to contact with the ball 18, and FIG. 4 shows the seating element 22 in an actuated or deformed position in which the ball 18 is in contact with the ball seat 16. The seating element 22 may embedded in the housing 12 or sleeve 20, or adhered or otherwise attached to an interior surface of the housing 12 or sleeve 20.

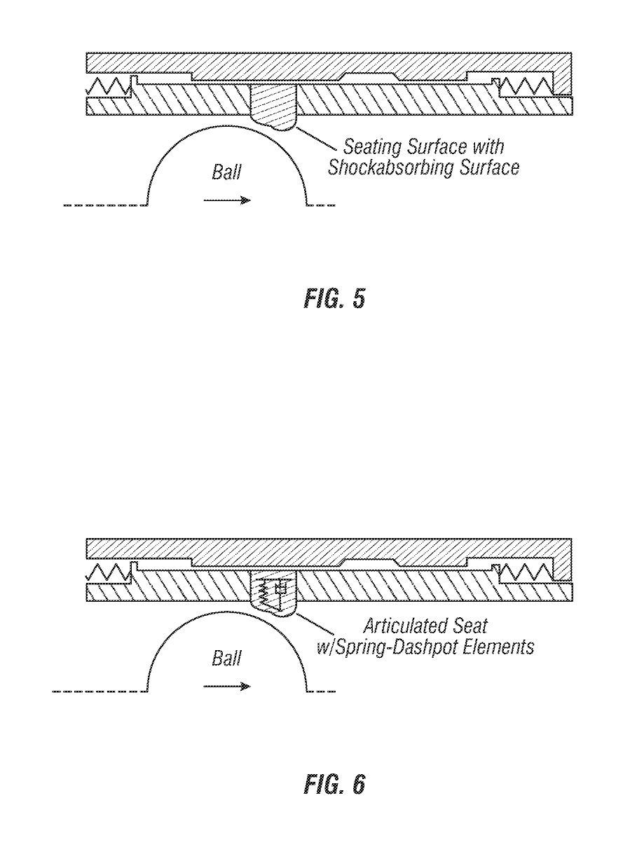

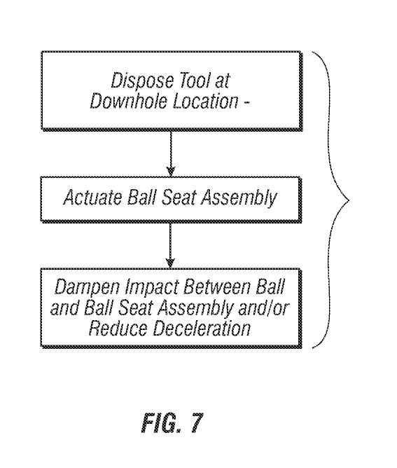

Referring to FIG. 5, in one embodiment, the seating element 22 includes a compliant region 26 such as a surface region that is made of the compliant material. The compliant region may be any desired portion of the seating element 22 that is configured to be disposed in the conduit 14. For example, the seating element 22 has a surface portion 26 made from an elastomeric material and a relatively rigid portion 28 that is made from a relatively rigid material such as steel.

Referring to FIG. 6, in one embodiment, the seating element 22 is operably connected to a damping mechanism 30 that acts as a shock absorber. The damping mechanism 30 is configured to at least partially attenuate impact energy and/or introduce a time delay in valve closure. In one embodiment, the seating element 22 includes both a compliant feature that deforms and/or radially moves to reduce impact and a damper that reduces rebound or oscillation.

In the example shown in FIG. 6, the damping mechanism 30 includes a spring element 32 operably connected to a dashpot element 34. The spring element 32, which in this example is a helical compression spring connected to the protrusion, acts to reduce the impact of the ball 18 on the ball seat 16 by allowing at least the protruding portion of the seating element 22 protrusion to radially retract or deform in response to contact with the ball. In this embodiment, the spring element 32 is fixedly attached at one end relative to the housing 12 or sleeve 20, and is attached to a movable or deformable portion of the seating element 22, such as a movable contoured member 36.

The dashpot element 34 is operably connected to the spring element 32, and resists the motion of the spring element 32 due to viscous friction caused by fluid therein being forced between chambers in the dashpot element 34. The amount of resistance is proportional to the amount of force exerted by the spring element 32 or a movable portion of the seating element 22, and thus the dashpot element can modulate compression of the spring element 34 and/or reduce the rebounding or springing back of the spring element 32. In this way, the number, magnitude and duration of oscillations of the ball seat 16 can be reduced, which also serves to reduce the number and magnitude of resulting pressure waves. In one embodiment, the spring element 32 and the dashpot element 34 are connected in series, i.e., force on the seating element 22 is transferred to the spring element 34, which compresses and in turn transfers force to the dashpot element 34 which resists the motion of the spring element 34 to reduce rebound.

In one embodiment, as shown in FIG. 6, the spring element 32 and the dashpot element 34 are configured to act in parallel, so that the spring element 32 and the dashpot element 34 act substantially simultaneously to reduce the impact on the seating element 32 and also resist movement of the seating element 22 to dampen the movement and reduce oscillation. In this embodiment, the spring element 32 and the dashpot element 34 are both fixedly attached to a movable or deformable portion of the seating element 22, such as the movable contoured member 36. However, this configuration is exemplary, as the spring element 32 and the dashpot element 34 may be connected to one another and to the seating element 22 in various configurations.

The damping mechanism 30 described herein is not limited to the specific embodiments described herein. The spring element 32 may take any suitable form, such as various compression springs including Belleville springs, spring clips, leaf springs, levers, and other mechanisms configured to reduce an impact of the ball 18. Likewise, the dashpot element 34 is not limited to a viscous friction damper and may be any device suitable to dampen motion.

The at least one seating component 22 described herein may also be included in various configuration. For example, the seating component 22 may be a single annular component at least partially protruding into the conduit 14, or may include a plurality of circumferentially arrayed protrusions or members extending into the conduit 14. In one embodiment, the seating component 22 includes multiple seating components 22 distributed axially to incrementally decelerate the ball 18.

The downhole tool 10 is not limited to that described herein. The downhole tool 10 may include any tool, carrier or component that includes a ball seat assembly. The carriers described herein, such as a production string and a screen, are not limited to the specific embodiments disclosed herein. A “carrier” as described herein means any device, device component, combination of devices, media and/or member that may be used to convey, house, support or otherwise facilitate the use of another device, device component, combination of devices, media and/or member. Exemplary non-limiting carriers include borehole strings of the coiled tube type, of the jointed pipe type and any combination or portion thereof. Other carrier examples include casing pipes, wirelines, wireline sondes, slickline sondes, drop shots, downhole subs, bottom-hole assemblies, and drill strings. In addition, the downhole tool 10 is not limited to components configured for downhole use.

FIG. 3 illustrates a method 40 of restricting fluid flow in a component. The method includes, for example, actuating a valve or packer in a downhole assembly. The method 40 includes one or more stages 41-43. Although the method is described in conjunction with the tool 10, the method can be utilized in conjunction with any device or system (configured for downhole or surface use) that utilizes a ball-seat assembly.

In the first stage 41, in one embodiment, the tool 10 is disposed at a downhole location, via for example a borehole string or wireline. In the second stage 42, the ball-seat assembly is actuated by releasing the ball 18 into the conduit 14, for example by dropping the ball 18 into the conduit 14 and/or pumping the ball 18 through the conduit 14. The ball 18 advances through the conduit 14 and impacts the ball seat 16. In the third stage 43, the at least one compliant and/or contoured seating element 22 reduces the impact between the ball 18 and the ball seat 16 and/or dampens movement resulting from contact between the ball 18 and the ball seat 16.

The systems and methods described herein provide various advantages over existing processing methods and devices. The embodiments described herein can significantly reduce surge pressure on the ball seat assembly by reducing impact and damping oscillations in the ball seat assembly. The embodiments are also useful in high flow rate configurations, in contrast to embedded axial spring designs that may not be adequate in such configurations (e.g., flow rate on the order of 80 bbl/min). The net reduction in pressure surge on the ball-seat assembly can enable the use of a wider range of construction materials and reduce the complexity of ball-seat design, for example by reducing the need for relatively complex ball seat designs to reduce impact. In addition, the apparatuses can allow for the ball seat to have a larger inner diameter due to the reduced contact stress.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention.

1. An apparatus for restricting fluid flow, comprising:
a ball receiving element disposed in a fluid conduit and configured to receive a ball that has been advanced through the fluid conduit and at least partially restrict fluid flow; and
at least one seating element at least partially disposed within the fluid conduit, the at least one seating element including at least one of: a shape that extends radially into the fluid conduit and is contoured axially to reduce a rate of deceleration of the ball upon contact with the ball receiving element, and a radially compliant element configured to reduce an impact between the ball and the ball receiving element.

2. The apparatus of claim 1, wherein the shape gradually extends further into the conduit as the at least one seating element extends from an upstream location to a downstream location.

3. The apparatus of claim 2, wherein the contour defines an at least partially elliptical shape along a longitudinal axis of the fluid conduit.

4. The apparatus of claim 1, wherein the radially compliant element includes a protruding portion disposed within the fluid conduit and having at least one of a radially retractable portion and an elastomeric portion.

5. The apparatus of claim 1, wherein the radially compliant element includes a spring element operably connected to a damping element, the damping element configured to proportionally resist radial movement of at least one of the spring element and the ball receiving element.

6. The apparatus of claim 5, wherein the damping element includes a dashpot.

7. The apparatus of claim 5, wherein the damping element is operable in series with the spring element and is configured to resist movement of the spring element and reduce oscillation of the spring element.

8. The apparatus of claim 5, wherein the damping element is operable in parallel with the spring element and is configured to resist movement of the spring element and the at least one seating element.

9. The apparatus of claim 1, wherein the at least one seating element includes a plurality of seating elements circumferentially arranged about a longitudinal axis of the fluid conduit.

10. The apparatus of claim 1, further comprising a carrier including the fluid conduit and configured to be disposed in a borehole.

11. The apparatus of claim 10, wherein the ball is configured to be at least one of dropped into and pumped through the fluid conduit.

12. A method of restricting fluid flow, comprising:
releasing a ball into a fluid conduit and receiving the ball in a ball receiving element disposed at the fluid conduit and at least partially restricting fluid flow; and
reducing an impact between the ball and the ball receiving element by at least one seating element at least partially disposed within the fluid conduit, the at least one seating element including at least one of: a contour defining a shape that extends radially into the fluid conduit and is contoured axially to reduce rate of deceleration of the ball upon contact with the ball receiving element, and a radially compliant element configured to reduce an impact between the ball and the ball receiving element.

13. The method of claim 12, wherein the shape gradually extends further into the conduit as the ball receiving element extends from an upstream location to a downstream location.

14. The method of claim 1, wherein the radially compliant element includes a protruding portion disposed with the fluid conduit and having at least one of a radially retractable portion and an elastomeric portion.

15. The method of claim 1, wherein reducing the impact includes actuating a spring element and damping radial movement of at least one of the spring element and the at least one seating element by a damping element operably connected to at least one of the spring element and the seating element.

16. The method of claim 15, wherein the damping element is at least one of:
operable in series with the spring element and is configured to resist movement of the spring element and reduce oscillation of the spring element; and
operable in parallel with the spring element and is configured to resist movement of the spring element and the ball receiving element.

17. An apparatus for restricting fluid flow, comprising:
a carrier configured to be disposed in a borehole in an earth formation, the carrier including a fluid conduit;
a ball receiving element at least partially disposed in the fluid conduit and configured to receive a ball that has been advanced through the fluid conduit to at least partially restrict fluid flow, the ball receiving element including:
a shape that extends radially into the fluid conduit and is contoured axially to reduce a rate of deceleration of the ball upon contact with the ball receiving element; and
a damping assembly configured to reduce an impact between the ball and the ball receiving element, the damping assembly including a radially extending spring element operably connected to a damping element, the damping element configured to proportionally resist radial movement of at least one of the spring element and the ball receiving element.

18. The apparatus of claim 18, wherein the damping element includes a dashpot.

19. The apparatus of claim 18, wherein the damping element is operable in series with the spring element and is configured to resist movement of the spring element and reduce oscillation of the spring element.

20. The apparatus of claim 18, wherein the damping element is operable in parallel with the spring element and is configured to resist movement of the spring element and the ball receiving element.
